(19) United States
(12) Patent Application Publication
(10) Pub. No.: US 2025/0121802 A1
(43) Pub. Date: Apr. 17, 2025

(54) VEHICLE WASHING APPARATUS

(71) Applicant: MAXAM INDUSTRIES LTD, Middlesbrough (GB)

(72) Inventor: Kevin MALLAM, Middlesbrough (GB)

(21) Appl. No.: 18/912,844

(22) Filed: Oct. 11, 2024

(30) Foreign Application Priority Data
Oct. 13, 2023 (GB) 2315756.3

(51) Int. Cl. B60S 3/04; C02F 1/44; C02F 103/44

(52) U.S. Cl. CPC B60S 3/04; C02F 1/441; C02F 2103/44

(57) ABSTRACT

An apparatus for washing vehicles that includes a first tank arranged to receive water from a water supply; a reverse osmosis system arranged to receive and process water from the water supply; a demineralisation system, in fluidic communication with the reverse osmosis system, for treating the water treated by the reverse osmosis system; and a second tank in fluidic communication with the demineralisation system; wherein: the first tank is arranged to receive untreated water from the water supply, and configured to supply such water for pre-washing the vehicle; and the second tank is arranged to receive the water treated by the demineralisation system, and configured to supply such water for rinsing the vehicle. A method for washing a vehicle using such apparatus is also provided.

### CROSS REFERENCE TO RELATED APPLICATIONS

This application claims priority from United Kingdom Patent Application No. GB 2315756.3, filed on Oct. 13, 2023, the entirety of which is hereby fully incorporated by reference herein.

### FIELD OF THE INVENTION

The present invention relates to a vehicle washing apparatus. The invention is particularly suitable, but by no means limited, for use by a user wishing to clean their vehicle (e.g. a car or van, etc.) in a residential or commercial setting.

### BACKGROUND TO THE INVENTION

It is well understood that the proper maintenance of a vehicle is an important contributory factor in respect of the vehicle's overall appearance, as well as the vehicle's lifespan. This is often particularly important for commercial vehicles bearing corporate information, which typically need to make a good impression upon customers/potential customers, though it will also be appreciated that privately-owned vehicles also benefit from proper maintenance.

In this context, one of the most common vehicle maintenance acts relates to the cleaning of a vehicle to remove dirt and grime which accumulates on the vehicle during use. Indeed, the market size of the car washing industry has been estimated at around 2.9 billion USD in 2022 alone, and is expected to grow to around 4.7 billion USD over the next ten years. The growth of this market is being caused, amongst other things, by a yearly increase in the number of vehicles being produced which require maintenance.

A common method for people to maintain their vehicles is to pass the vehicle through a car wash system, which automatically cleans the vehicle in several minutes. However, such machines often suffer from being located at a significant distance from where the vehicle is usually kept (and hence time and money are lost in travelling to/from the automated car wash), as well as being inappropriate to clean certain types of vehicle, e.g. luxury vehicles, large vehicles, convertible vehicles, etc.

As a result, many vehicle owners often prefer to take a manual vehicle cleaning approach, which often involves a person using water and a sponge to clean the vehicle. Sometimes, a vehicle-cleaning shampoo may be added to the bucket of water to assist in the breakdown of dirt and grime during the cleaning process, in an attempt to reduce the amount of labour required to clean the vehicle. This approach is tedious and time-consuming, often requiring the use of multiple buckets of water (and potentially even hot water) to clean the vehicle entirely, as the dirt and grime is usually transferred from the sponge into the water contained within the bucket when the vehicle is being cleaned. Problematically, dirty water in the bucket may cause swirls and scratches on vehicle paintwork due to the presence of e.g. grit in the water. This problem is particularly pronounced in the “detailing world”, and particularly so in the context of cleaning unique/luxury vehicles such as high-value cars, where the vehicles are required to be cleaned to an extremely high standard and finish.

In this regard, so-called “pressure washer” systems, which are used to pressurise water and subsequently expel water at pressure via a wash gun/wash lance towards a vehicle, may be used in an attempt to reduce the amount of labour required to wash the vehicle (as well as to remove the need to fill up multiple buckets of water when cleaning the vehicle).

However, depending on the quality of the water being used to clean the vehicle, the cleaning of the vehicle may be problematic when using either of the above-mentioned methods.

For instance, in areas where the water is “hard” (i.e. the water that has high mineral content), rinsing the vehicle with hard water causes hard water spotting on the vehicle's paintwork and glass, which can be particularly difficult to remove. Also, removing such spotting may also cause damage to the vehicle's paintwork/glass during removal, e.g. by abrasion caused by sponging/buffing off minerals precipitated onto the vehicle's surface once the hard water has evaporated. Given that in the UK alone, around 60% of the water supplied from the mains to a premises is hard water, many vehicles may end up being rinsed with water which simply causes problems later.

There is therefore a desire for a vehicle washing apparatus which addresses at least some of the above problems.

### SUMMARY OF THE INVENTION

The present invention is set out in the appended independent claims. Optional features are set out in the appended dependent claims.

According to a first example, an apparatus for washing vehicles is disclosed, the apparatus comprising: a first tank arranged to receive water from a water supply; a reverse osmosis system arranged to receive and process water from the water supply; a demineralisation system, in fluidic communication with the reverse osmosis system, for treating the water treated by the reverse osmosis system; and a second tank in fluidic communication with the demineralisation system; wherein: the first tank is arranged to receive untreated water from the water supply, and configured to supply such water for pre-washing the vehicle; and the second tank is arranged to receive the water treated by the demineralisation system, and configured to supply such water for rinsing the vehicle. Beneficially, the use of such an apparatus provides for a high-quality of cleaning of vehicles in areas having poor water quality.

Optionally, the first tank may be further configured to receive waste water from the reverse osmosis system. Advantageously, this waste water may be used during pre-washing of the vehicle rather than being wasted.

Optionally, the apparatus may further comprise: a first adjustable pressure pump, in fluidic communication with the first tank, connectable to a first hose, and a second adjustable pressure pump, in fluidic communication with the second tank, connectable to a second hose. Optionally, the apparatus may further comprise the first hose and the second hose.

Optionally, the first hose and the second hose may be retractable onto respective reels for compact storage when not in use.

Optionally, the first hose may be connectable to a first quick-release pressure vessel, and the second hose may be connectable to a second quick-release pressure vessel. Optionally, the apparatus may further comprise the first quick-release pressure vessel and the second quick-release pressure vessel.

Optionally, the first quick-release pressure vessel may comprise a detergent, and the second quick-release pressure vessel may comprise a hydrophobic treatment agent. Beneficially, use of these cleaning agents provides for a high-quality spotless finish on the vehicle's surface.

Optionally, the apparatus may further comprise a first inlet for receiving water from the water supply, the first inlet being in fluidic communication with the first tank and the reverse osmosis system.

Optionally, the apparatus may comprise a means for measuring the quality of the water received from the water supply, and for measuring the water quality of the treated water.

Optionally, the first pump and the second pump may be releasably mounted onto a single plate. Beneficially, the plate may provide a dampening effect to reduce the noise/vibrations caused by the pumps when in operation.

Optionally, the first tank may comprise a first float valve operable to shut off a supply inlet of untreated water from the water supply, and the second tank may comprise a second float valve operable to shut off a supply inlet of water treated by the demineralisation system. Further optionally, the first and second tanks may comprise an overflow outlet.

Optionally, the first float valve may be configured to shut off the supply of untreated water at a lower water level in the first tank than the water level in the second tank at which the second float valve shuts off the supply of water treated by the demineralisation system.

Optionally, the overflow outlet may be provided in each of the first tank and second tank at a level below that of the supply inlet of each respective float valve.

Optionally, the apparatus may further comprise a one-way valve between the first tank and the first pump, and a one-way valve between the second tank and the second pump. When the apparatus comprises a first inlet, the apparatus may optionally further comprise a one-way valve between the water supply and the first inlet.

When the apparatus comprises a first hose and a second hose, the apparatus may optionally be self-contained within a housing. Further optionally, the first tank, the second tank, the first pump and the second pump may be contained within a central portion of the housing; the first hose may be extendable from a first peripheral portion of the housing; and the second hose may be extendable from a second peripheral portion of the housing. Yet further optionally, the central portion of the housing may comprise: a first means for displaying the volumetric contents of the first tank; and a second means for displaying the volumetric contents of the second tank. Optionally, the first means for displaying the volumetric contents of the first tank may comprise a first sight gauge, and the second means for displaying the volumetric contents of the second tank may comprise a second sight gauge.

Optionally, the central portion of the housing may comprise at least one storage portion for storing items.

According to further example, a method for washing a vehicle using the apparatus described above is disclosed, the method comprising: applying water from the first tank onto the vehicle to pre-wash the vehicle; and applying water from the second tank onto the vehicle to rinse the vehicle.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

### BRIEF DESCRIPTION OF THE DRAWINGS

The invention will now be described by way of example only with reference to the attached figures in which:

FIG. 1 is a simplified schematic illustration of a vehicle washing apparatus;

FIG. 2 is a simplified schematic illustration of the vehicle washing apparatus of FIG. 1 within a self-contained housing;

FIG. 3 is a simplified schematic illustration of a front view of the vehicle washing apparatus within the self-contained housing shown in FIG. 2; and

FIG. 4 is a simplified schematic illustration of an alternative vehicle washing apparatus to that illustrated in FIG. 1.

In the figures, like elements are indicated by like reference numerals throughout.

### DETAILED DESCRIPTION OF PREFERRED EMBODIMENTS

The present embodiments represent the best ways known to the Applicant of putting the invention into practice. However, they are not the only ways in which this can be achieved.

### Vehicle Washing Apparatus

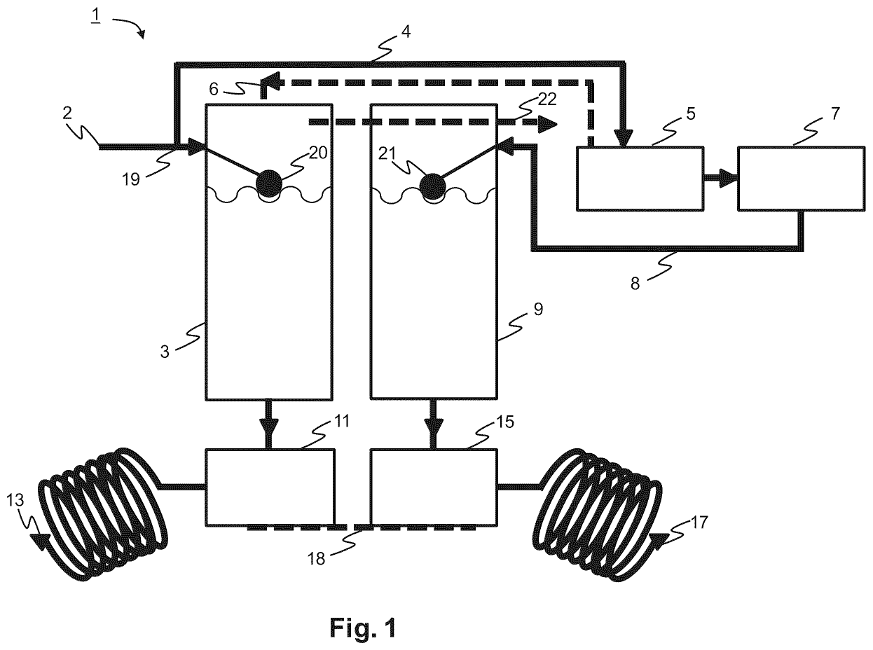

A vehicle washing apparatus embodying the present invention will now be described in overview by way of example only with reference to FIG. 1.

In the illustrated example, the vehicle washing apparatus 1 has a first tank 3, referred to herein as a pre-wash tank 3, arranged to receive water from a water supply 2 (preferably supplied at about 2 bars of pressure). The water supply 2 may be a water supply in a domestic setting (e.g. the water is supplied using a 15 mm diameter or 22 mm diameter pipe) or in an industrial/commercial setting (e.g. the water is supplied using a 28 mm diameter pipe, or a pipe having a larger diameter). Depending on where apparatus 1 is deployed or installed, the apparatus 1 may be hard plumbed (or flexibly plumbed) into the water supply 2. Accordingly, it will be appreciated that the pre-wash tank stores water which has not been treated by any treatment processes beyond those of the water supplier.

The apparatus 1 also has a second tank 9, referred to herein as a rinse tank 9, which is arranged to receive water which has been treated as described in the following.

Specifically, to treat water supplied from water supply 2, the apparatus 1 comprises a reverse osmosis system 5, which receives (via conduit 4, e.g. a pipe or hose) and treats water from the water supply 2 by passing the water through one or more membranes/filters to separate dissolved substances from the supplied water. It will be appreciated that the membranes/filters may be replaced, as needed. The reverse osmosis system 5 therefore acts a first stage in the purification of supplied water, by removing contaminants which would otherwise be resident in the supplied water. During the reverse osmosis procedure, so-called “waste water” is generated and expelled by the reverse osmosis system 5. Instead of this unwanted waste water being discarded in a non-environmentally friendly manner, the pre wash tank 3 may be configured to receive this waste water via an optional conduit 6. Such waste water is perfectly acceptable for the pre-washing of a vehicle, which will be described in more detail later.

To further treat water supplied from water supply 2, the apparatus 1 also uses a demineralisation system 7, which is in fluidic communication with the reverse osmosis system 5, to treat the water which was treated by the reverse osmosis system 5. Beneficially, this second stage of treatment of the supplied water removes any lingering charged ions, and/or smaller molecular weight contaminants, which may remain in the water after the first stage of treatment, before it is supplied to the rinse tank 9, via conduit 8 (e.g. a pipe or hose). Accordingly, the water that is stored in and dispensed from the rinse tank 9 is demineralised and free from unwanted contaminants.

It will be appreciated that the demineralisation system 7 may be of the resin filter type, or mixed-bed ion exchanger type, etc. It will further be appreciated that filters used in the demineralisation system 7 may be replaced as needed.

Beneficially, therefore, using water which has been treated in this way during the rinse stage of washing a vehicle means that there is no risk of any hard water spotting occurring on the vehicle's paintwork/plastic surfaces, nor etching onto the vehicle's glass, which would otherwise create a very difficult task to buff or polish back off without damaging the vehicle. Problems associated with hard water spotting are particularly pronounced in the context of luxury vehicles, which often have special paints applied, such as matte finish paints, or lacquered finishes, decals, etc., the damage of which could be extremely costly to rectify.

In the example illustrated in FIG. 1, the apparatus 1 further comprises a first adjustable pressure pump 11, in fluidic communication with the pre-wash tank 3. The first adjustable pressure pump 11 may be a high-pressure pump, which is able to operate within a range of about 600 psi to 1600 psi (or another range), and which may be supplied with power using a domestic or commercial power supply depending on where apparatus 1 is being deployed. As illustrated in FIG. 1, pressure pump 11 is connected to a first connectable hose 13. The first hose 13 may have a quick-release member at its terminus, onto which a first wash gun (not illustrated) may be attached. The first hose 13, which is suitable for high-pressure applications (typically, water expelled from the first hose 13 is expelled at around 1200 psi pressure), may be of any length, depending on where apparatus 1 is deployed. In a domestic setting, for example, the first hose 13 may have a length of around 15 metres, to enable straightforward storage of the hose 13 when not in use. Such storage may be facilitated in any setting by, for example, retracting the hose 13 onto a reel using a manual or automated winding mechanism.

In the example illustrated in FIG. 1, the apparatus 1 also comprises a second adjustable pressure pump 15, in fluidic communication with the rinse tank 9. The second adjustable pressure pump 15 may also be a high-pressure pump, and may be set to operate at about 800 psi pressure (or at an alternative pressure) to provide a steady supply of treated water when rinsing the vehicle. The second pump 15 may be supplied with power using the same power supply as that used for the first pump 11, or may be supplied with power from a different power supply as needed.

As illustrated in FIG. 1, the second pressure pump 15 is connected to a second connectable hose 17. The second hose 17 may have a quick-release member at its terminus, onto which a second wash gun (not illustrated) may be attached. The second hose 17, which is also suitable for high-pressure applications (typically, treated water expelled from the second hose 17 is expelled at around 1.5 bar), may be of any length, depending on where apparatus 1 is deployed. In a domestic setting, for example, the second hose 17 may have a length of around 15 metres, to enable straightforward storage of the hose 17 when not in use. Such storage may be facilitated in any setting by, for example, by retracting the hose 17 onto a reel using a manual or automated winding mechanism.

To provide a high-quality clean, the first hose 13 may be connectable to a first quick-release pressure vessel (e.g. connected to the first wash gun, not illustrated in FIG. 1) which may comprise a detergent, and the second hose 17 may be connectable to a second quick-release pressure vessel (e.g. connected to the second wash gun, not illustrated in FIG. 1) which may comprise a hydrophobic treatment agent. The quick-release vessels provide for an adjustable flow of the contents stored therein, and such quick-release pressure vessels when used in conjunction with a wash gun/wash lance are sometimes referred to as “snow foam cannons” due to the foam-like application of their contents onto a vehicle.

In one example, the ratio of detergent to water in the first quick-release pressure vessel may be 1:4 (e.g. 200 mL detergent: 800 mL water), whilst the ratio of hydrophobic treatment agent to water in the second quick-release pressure vessel may be 1:9 (e.g. 100 mL detergent: 900 mL water). It will, however, be appreciated that alternative ratios may be used instead.

Accordingly, a vehicle may be pre-washed with untreated water from the pre-wash tank 3 and a detergent, the detergent assisting with the initial removal of dirt and grime from the vehicle, before being rinsed with a hydrophobic treatment agent using water from the rinse tank 9 which has been treated by the apparatus 1, as described in more detail later. Beneficially, the hydrophobic treatment agent, which dries onto the vehicle post treatment, keeps dirt and grime away from the vehicle for longer because the treatment causes most dirt/grime to “bead off” (or “pearl off”) the vehicle (which also makes subsequent washing of the vehicle more straightforward).

Whilst the apparatus illustrated in FIG. 1 comprises a first inlet 19 for receiving water from the water supply 2, with the first inlet 19 being in fluidic communication with the pre-wash tank 3 and the reverse osmosis system 5, this need not be the case. Instead, water may be supplied independently to the pre-wash tank 3 and to the reverse osmosis system 5 as may be needed depending on how apparatus 1 is deployed. For instance, in a commercial setting, there may be an appreciable distance between the pre-wash tank 3 and the reverse osmosis system 5, which may necessitate independent connections to respective mains water supplies.

Additionally, the apparatus 1 may also include a means for measuring the quality of the water received from the water supply 2 (not illustrated in FIG. 1), and for measuring the water quality of the treated water. For instance, a total dissolved solids (TDS) meter may be used, which provides the user of the apparatus 1 with an indication of the water quality in the pre-wash tank 3 as well as the water quality in the rinse tank 9. Once the water quality at the rinse tank 9 reaches an unacceptable threshold for high-quality rinsing (e.g. around 5 ppm), the filters of the reverse osmosis system 5 and the demineralisation system 7 can be inspected and replaced as needed.

To aid with servicing/replacement of the first and second pumps 11, 15, the pumps 11, 15 may be releasably mounted onto a single plate 18. The plate 18 may also provide a dampening effect to reduce the noise/vibrations caused by the pumps 11, 15 when in operation, which may be of particular benefit if the apparatus 1 is being operated in a relatively constrained space such as an average-sized domestic garage. A power supply junction may also be provided on the plate 18 to facilitate ease of connection of pumps 11, 15 to a single source of power instead of separate independent supplies of power.

The flow of water into the pre-wash tank 3 and rinse tank 9 may be reliably governed by respective float valves 20, 21 (or by other suitable devices) in the manner illustrated in FIG. 1. More particularly, the pre-wash tank 3 comprises a first float valve 20 operable to shut off a supply inlet of untreated water from the water supply 2, and the rinse tank 9 comprises a second float valve 21 operable to shut off a supply inlet of water treated by the demineralisation system 7. An overflow outlet 22 may also be provided at the pre-wash tank 3 and the rinse tank 9 to allow for the egress of water from the tanks 3, 9 before pressure can build in the case of an unintended overfilling over the tanks 3, 9.

To further govern the flow of water within the apparatus 1, the apparatus 1 may also incorporate a one-way valve between the water supply 2 and the first inlet 19, a one-way valve between the pre-wash tank 3 and the first pump 11, and a one-way valve between the rinse tank 9 and the second pump 15, thereby avoiding any unintended flow of water in a direction opposite to those illustrated in FIG. 1.

Should apparatus 1 be deployed in a domestic setting, the tanks 3, 9 may have a volume of around 28 L, as this volume is sufficient to clean a few vehicles (typically, 5 L of water is needed from each tank 3, 9 to clean one vehicle). Should apparatus 1 be deployed in a commercial setting, the tanks 3, 9 may have a volume of 100 L or more, as this volume is sufficient to clean many vehicles.

### Housed Vehicle Washing Apparatus

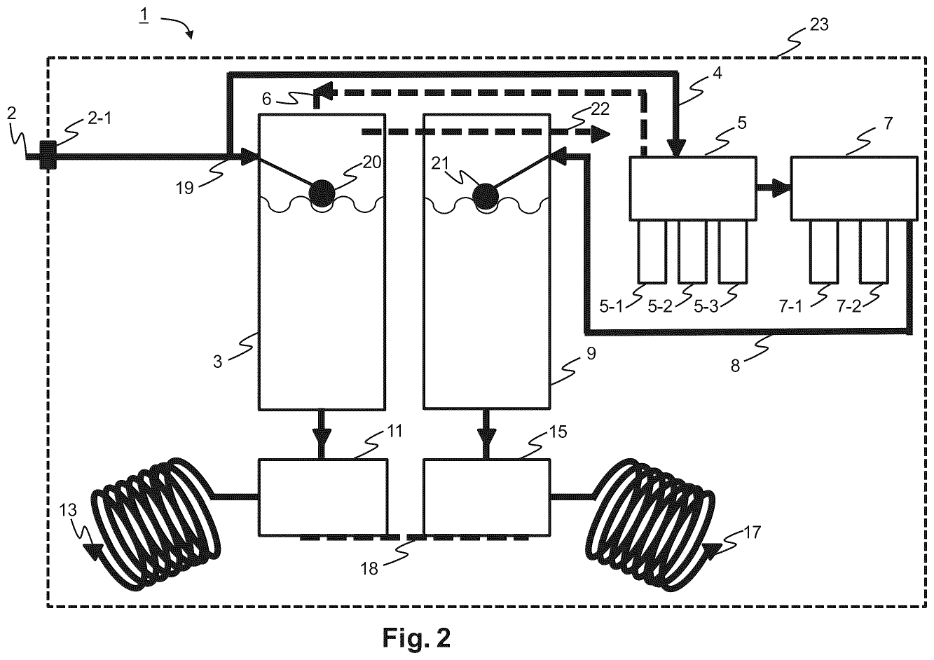

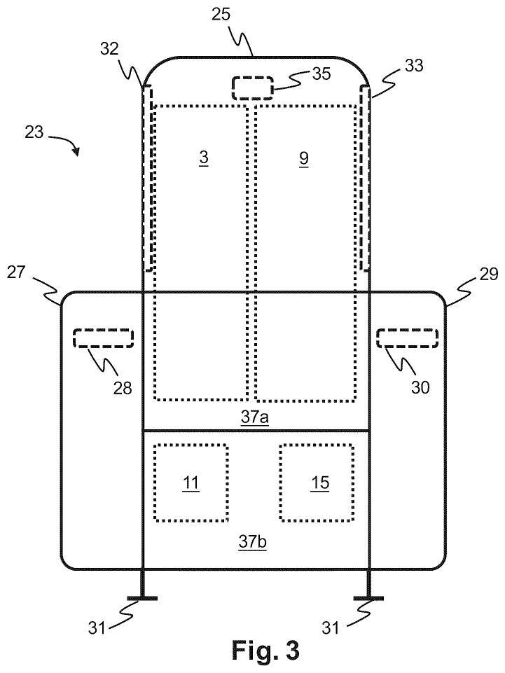

Reference will now be made to FIGS. 2 and 3, which illustrate the apparatus 1 of FIG. 1 when self-contained within a housing 23.

FIG. 2 illustrates the apparatus 1 of FIG. 1 being self-contained within a housing 23 (indicated by the dotted line). Common features of the apparatus 1 described with reference to FIG. 1 are applicable to the apparatus 1 depicted in FIG. 2, and the description thereof will not be repeated here. The main difference between FIG. 1 and FIG. 2, other than housing 23, is the connection point 2-1 which provides a single point of connection to a mains water supply 2.

As shown, the reverse osmosis system 5 may comprise a removable pre-filter 5-1, a removable membrane filter 5-2, and a removable post-filter 5-3 (although more or fewer removable filters may be employed by the reverse osmosis system 5). Similarly, the demineralisation system 7 may comprise two removable filters 7-1, 7-2 (although more or fewer removable filters may be employed by the demineralisation system 7). It will of course be appreciated that the reverse osmosis system 5 and the demineralisation system 7 shown in FIG. 1 may also comprise these filters/membranes.

FIG. 3 schematically illustrates, in a front view, the housing 23 in which apparatus 1 is self-contained. Whilst not drawn to scale, FIG. 3 illustrates the approximate location of the pre-wash tank 3, the rinse tank 9, the first pump 11 and the second pump 15 within the housing 23. In the illustrated example, the pre-wash tank 3, the rinse tank 9, the first pump 11 and the second pump 15 are within a central portion 25 the housing 23. This central portion may be accessed, e.g. for servicing, via a removable front cover. The first hose 13 is extendable from within a first peripheral portion 27 of the housing via a first hose outlet 28, and the second hose 17 is extendable from within a second peripheral portion 29 of the housing via a second hose outlet 30. The respective first and second hose outlets 28, 30 may comprise rollers (not illustrated) to facilitate extraction/retraction of the first and second hoses 13, 17 out of/into their respective peripheral portions 27, 29 of the housing 23.

Housing the apparatus 1 in this way provides for a convenient and attractive way of keeping the various components of the apparatus within a self-contained unit, which is particularly useful in a domestic setting where space may be at a premium, as well as where having various hoses and pumps otherwise lying around could represent a trip hazard (or potentially other hazards, e.g. risks of equipment being broken accidentally when reversing a vehicle into a garage). Moreover, installation of the apparatus 1 and subsequent servicing of the apparatus 1 by an engineer (e.g. to change filters/pumps), when self-contained within the housing 23, is made more procedurally straightforward. The housing 23 may comprise feet 31 onto which the housing stands. The feet 31 may be, for instance, be fixed rubber feet 31, thereby avoiding damage to the surface on which the housed apparatus 1 is installed. Instead, the feet 31 may be replaced with castors to enable straightforward placement and relocation of the housed apparatus 1 within a premises.

The central portion 25 of the housing 23 may also have a first means 32 for displaying the volumetric contents of the pre-wash tank 3, and a second means 33 for displaying the volumetric contents of the rinse tank 9 (e.g. as generally shown on the central portion 25 of the housing 23). For instance, the first means 32 for displaying the volumetric contents of the pre-wash tank 3 may be a first sight gauge, and the second means 33 for displaying the volumetric contents of the rinse tank 9 may be a second sight gauge. The user of the apparatus 1 according to this example is therefore able to see if the tanks 3, 9 are filled to a suitable level to commence cleaning of a vehicle, without having to remove the front cover of the central portion 25 of the housing 23. If the level is too low, the apparatus 1 may left to run until a suitable level of water is contained within both tanks.

To further aid the user of the apparatus 1, the above-described TDS meter may be located on the housing 23, e.g. as generally shown at 35 on the central portion 25 of the housing 23 (though it will be appreciated that the TDS meter may be located elsewhere on the housing 23), to provide the user of the apparatus 1 with a ready indication of the water quality at both tanks 3, 9. Once the water quality at the rinse tank 9 reaches an unacceptable threshold for high-quality rinsing (e.g. around 5 ppm), the filters of the reverse osmosis system 5 and the demineralisation system 7 can be inspected and replaced as needed.

The central portion 25 of the housing 23 may also have a portion for storing items useful to a user of apparatus 1 when cleaning a vehicle, such items including sponges, cloths, wash mitts, chemical agents (e.g. detergents, hydrophobic treatment agents, etc), wash guns, quick-release vessels, and brushes (though it will be appreciated that storage may be provided elsewhere within the housing 23). This storage portion may be one or more bins (illustrated at 37a, 37b in FIG. 3) which adopt a fold-out design. The storage portion may be manufactured from, for example, ABS plastic, carbon fibre, or other suitable materials.

The frame of housing 23 may be manufactured from, for example, extruded aluminium or carbon fibre, or from other suitable materials. Panels may then be placed and affixed into housing 23 to hide the apparatus 1, provide a clean aesthetic appearance, and shield the apparatus 1 from water spray when the apparatus 1 is in use.

### Further Embodiment

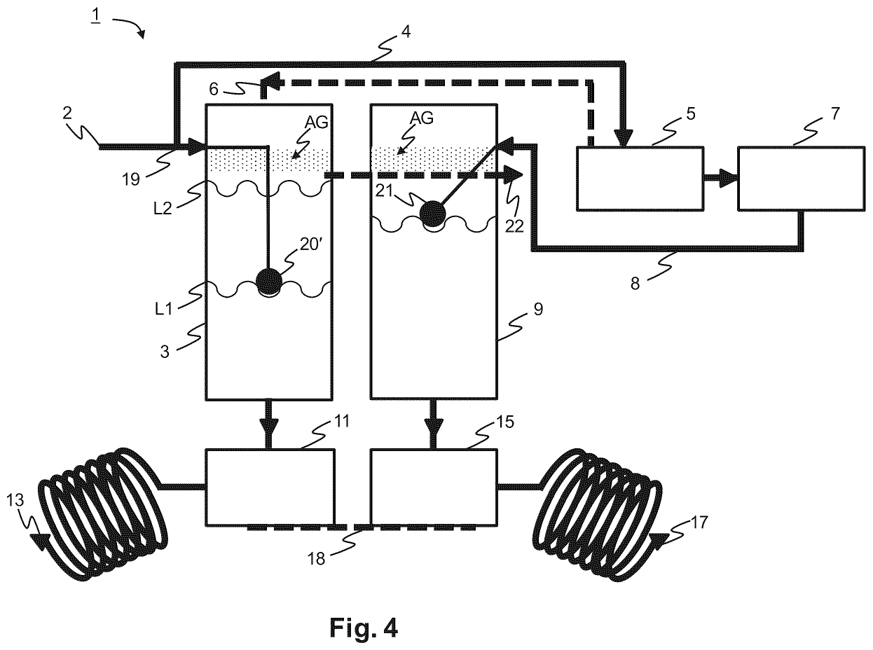

Reference will now be made to FIG. 4, which illustrates the apparatus 1 of FIG. 1 having an alternative configuration.

Specifically, the principal difference between the apparatus of FIG. 1 and that of the further embodiment illustrated in FIG. 4 relates to the type of float valve used in the pre-wash tank 3, and the location of the overflow outlet 22. The description of corresponding components, depicted with like reference signs, will not be repeated here.

In the example illustrated in FIG. 4, the pre-wash tank 3 comprises a long float valve 20′, and the overflow outlet 22 of the pre-wash tank 3 is located below the level of the supply inlet of the untreated water from the mains water supply 2. Similarly, the overflow outlet 22 of the rinse tank 9 is also located below the level of the supply inlet of the treated water from the demineralisation system 7.

By using the long float valve 20′, the pre-wash tank 3 may be filled from the mains water supply 2 to a first level L1 at which the float valve 20′ shuts off the supply of water from the mains water supply 2. As can be seen from FIG. 4, the first level L1 is lower than the water level in the rinse tank 9 at which the second float valve 21 shuts off its supply of water treated by the demineralisation system 7.

Then, a remaining volume of the pre-wash tank 3 may be filled with waste permeate water, up to the level L2 indicated in FIG. 4, which is suppled via the conduit 6 which runs between the reverse osmosis system 5 and the pre-wash tank 3.

By virtue of the overflow outlet 22 being below the supply inlets of the float valves 20′, 21, the apparatus 1 may be made compliant with regulations in certain jurisdictions by incorporating an airgap AG between the overflow outlet 22 and the supply inlets of the float valves 20′, 21, such that any excessive high-water levels do not reach the mains supply inlet 2. For instance, in the UK, such a configuration will mean that the apparatus 1 adheres to Water Authority Bylaws by incorporating a Type A Airgap into the tanks 3, 9.

### Method for Cleaning a Vehicle Using the Vehicle Washing Apparatus

A method for cleaning a vehicle using the above-described vehicle washing apparatus 1 will now be described.

The first step of the cleaning process is to apply detergent to the vehicle by using the wash gun, comprising the first quick release vessel which contains detergent, connected to the first hose 13. This “snow foam gun” allows the user to spray an even coating of detergent/foam over the entire body of the vehicle, and the extractable/retractable nature of the first hose 13 allows the user to reposition themselves as needed when applying detergent. The detergent acts rapidly to work on dirt and other debris. Untreated water, supplied from the pre-wash tank 3 via the first pump 11 and first hose 13, is suitable for this stage of the cleaning procedure. Should the vehicle be particularly heavily soiled, the foam may be left on the vehicle for a few minutes to assist in the breakdown of heavy dirt/debris. As the level of water in pre-wash tank 3 drops, the float valve 20 drops, thereby causing the tank 3 to be refilled with water from the water supply 2 (and waste permeate water received from the reverse osmosis system 5 when in operation).

Once the detergent has worked into the dirt/grime, the first quick-release vessel is disconnected from the wash gun, and the vehicle may then be sprayed down with water from the pre-wash tank 3. This procedure may be repeated, as needed, depending on the condition of the vehicle being cleaned. A fine wash mitt may also be used to remove any particularly stubborn dirt.

Generally, the vehicle at this stage will look quite clean. However, the water which remains on the surface of the vehicle is untreated water from the pre-wash tank 3. Accordingly, if the apparatus 1 is used in an area of low-quality water/hard water, when this untreated water dries an undesired finish would be realised due to contaminants present in the untreated water precipitating on the surface of the vehicle during drying.

Therefore, the second stage of the cleaning process is to apply treated water from the rinse tank 9, which is supplied via the second pump 15 and the second hose 17.

This second stage applies a hydrophobic treatment agent to the vehicle by using the wash gun, comprising the second quick release vessel which contains the hydrophobic treatment agent, connected to the second hose 17. This “snow foam gun” allows the user to spray an even coating of hydrophobic treatment agent over the entire body of the vehicle, and the extractable/retractable nature of the second hose 17 allows the user to reposition themselves as needed when applying the hydrophobic treatment agent. As the level of water in the rinse tank 9 drops, the float valve 21 drops, thereby causing the tank 9 to be refilled with treated water from the demineralisation system 7 (and also causing waste permeate water from the reverse osmosis system 5 to be provided to the pre-wash tank 3).

Therefore, the vehicle dries having been sprayed with water which has been treated, and hence does not contain contaminants which would have otherwise precipitated during evaporation. Accordingly, a spotless finish may be achieved, resulting in a particularly clean vehicle having very shiny painted/glass surfaces.

The first and second hoses 13, 17 may then be retracted into the apparatus 1, once the cleaning procedure has been completed.

Further beneficially, cleaning a vehicle in this way using the apparatus 1 described herein results in a build-up of hydrophobic coating on the vehicle, which results in the need for less washing and cleaning of the vehicle (particularly advantageous e.g. for fleet operators/small business operators) because water simply “pearls” /“beads” off the vehicle. Indeed, it has even been observed that after cleaning as described above, a vehicle's windscreen wipers did not need to be activated on a motorway journey in rainy conditions as visibility was maintained due to water beading off the windscreen, and hence the apparatus 1 also provides a safety benefit relative to traditional cleaning methods.

The detergent/hydrophobic treatment agents described herein are pH neutral, and do not damage or strip back protection which may have already been applied to a vehicle (e.g. ceramic paintwork protection coatings, car wax, car polish, etc.). Instead, the hydrophobic treatment agent may act in combination with any of the above-noted forms of protection.

### Modifications and Alternatives

Detailed examples have been described above. As those skilled in the art will appreciate, a number of modifications and alternatives can be made to the above examples whilst still benefiting from the inventions embodied therein.

According to one alternative, the housing 23 may be covered in panels to which provide a finish which corresponds to a given vehicle, e.g. the panels may be constructed of carbon fibre to match the carbon fibre of a given vehicle. Instead, or in addition, the panels may be painted in the same colour of a given vehicle. The storage portion 37 may also be colour-matched to the panels of the housing 23, as desired.

The housing 23 may, according to one example, have a depth of around 400 mm. This depth will allow the apparatus 1 when self-contained in such a housing 23 to fit perpendicular to a garage door, as either side of an average garage door has a depth of around 400 mm.

The pressure pumps 11, 15 may optionally be provided with a low water cut out switch, which will shut the pump down in the case where the tanks 3, 9 supplying the pumps have been depleted of water (e.g. due to overuse).

In one alternative, the apparatus 1 may be installed within a vehicle, such as a van, with power being supplied to the apparatus 1 from a domestic/commercial property and water being supplied to the apparatus 1 at that property (e.g. via a garden hosepipe).

Various other modifications will be apparent to those skilled in the art and will not be described in further detail here.

The specification can be readily understood with reference to the following Numbered Paragraphs:

Numbered Paragraph 1. An apparatus for washing vehicles, the apparatus comprising:
a first tank arranged to receive water from a water supply;
a reverse osmosis system arranged to receive and process water from the water supply;
a demineralisation system, in fluidic communication with the reverse osmosis system, for treating the water treated by the reverse osmosis system; and
a second tank in fluidic communication with the demineralisation system; wherein:
   the first tank is arranged to receive untreated water from the water supply, and configured to supply such water for pre-washing the vehicle; and
   the second tank is arranged to receive the water treated by the demineralisation system, and configured to supply such water for rinsing the vehicle.

Numbered Paragraph 2. The apparatus according to Numbered Paragraph 1, wherein the first tank is further configured to receive waste water from the reverse osmosis system.

Numbered Paragraph 3. The apparatus according to Numbered Paragraph 1 or Numbered Paragraph 2, wherein the apparatus further comprises:
a first adjustable pressure pump, in fluidic communication with the first tank, connectable to a first hose, and
a second adjustable pressure pump, in fluidic communication with the second tank, connectable to a second hose.

Numbered Paragraph 4. The apparatus according to Numbered Paragraph 3, further comprising the first hose and the second hose.

Numbered Paragraph 5. The apparatus according to Numbered Paragraph 4, wherein the first hose and the second hose are retractable onto respective reels.

Numbered Paragraph 6. The apparatus according to Numbered Paragraph 4 or Numbered Paragraph 5, wherein the first hose is connectable to a first quick-release pressure vessel, and the second hose is connectable to a second quick-release pressure vessel.

Numbered Paragraph 7. The apparatus according to Numbered Paragraph 6, further comprising the first quick-release pressure vessel and the second quick-release pressure vessel.

Numbered Paragraph 8. The apparatus according to Numbered Paragraph 6 or Numbered Paragraph 7, wherein the first quick-release pressure vessel comprises a detergent, and the second quick-release pressure vessel comprises a hydrophobic treatment agent.

Numbered Paragraph 9. The apparatus according to any preceding Numbered Paragraph, further comprising a first inlet for receiving water from the water supply, the first inlet being in fluidic communication with the first tank and the reverse osmosis system.

Numbered Paragraph 10. The apparatus according to any preceding Numbered Paragraph, wherein the apparatus comprises a means for measuring the quality of the water received from the water supply, and for measuring the water quality of the treated water.

Numbered Paragraph 11. The apparatus according to any preceding Numbered Paragraph, wherein the first pump and the second pump are releasably mounted onto a single plate.

Numbered Paragraph 12. The apparatus according to any preceding Numbered Paragraph, wherein the first tank comprises a first float valve operable to shut off a supply inlet of untreated water from the water supply, and the second tank comprises a second float valve operable to shut off a supply inlet of water treated by the demineralisation system.

Numbered Paragraph 13. The apparatus according to any preceding Numbered Paragraph, wherein the first and second tanks comprise an overflow outlet.

Numbered Paragraph 14. The apparatus according to Numbered Paragraph 13 when dependent on Numbered Paragraph 12, wherein the first float valve is configured to shut off the supply of untreated water at a lower water level in the first tank than the water level in the second tank at which the second float valve shuts off the supply of water treated by the demineralisation system.

Numbered Paragraph 15. The apparatus according to Numbered Paragraph 14, wherein the overflow outlet is provided in each of the first tank and second tank at a level below that of the supply inlet of each respective float valve.

Numbered Paragraph 16. The apparatus according to any preceding Numbered Paragraph, wherein the apparatus further comprises a one-way valve between the first tank and the first pump, and a one-way valve between the second tank and the second pump.

Numbered Paragraph 17. The apparatus according to Numbered Paragraph 16 when dependent on Numbered Paragraph 9, further comprising a one-way valve between the water supply and the first inlet.

Numbered Paragraph 18. The apparatus according to any preceding Numbered Paragraph when dependent on Numbered Paragraph 4, wherein the apparatus is self-contained within a housing.

Numbered Paragraph 19. The apparatus according to Numbered Paragraph 18, wherein:
the first tank, the second tank, the first pump and the second pump are contained within a central portion of the housing;
the first hose is extendable from a first peripheral portion of the housing; and
the second hose is extendable from a second peripheral portion of the housing.

Numbered Paragraph 20. The apparatus according to Numbered Paragraph 19, wherein the central portion of the housing comprises:
a first means for displaying the volumetric contents of the first tank; and
a second means for displaying the volumetric contents of the second tank.

Numbered Paragraph 21. The apparatus according to Numbered Paragraph 20, wherein the first means for displaying the volumetric contents of the first tank comprises a first sight gauge, and wherein the second means for displaying the volumetric contents of the second tank comprises a second sight gauge.

Numbered Paragraph 22. The apparatus according to any of Numbered Paragraphs 18 to 21, wherein the central portion of the housing comprises at least one storage portion for storing items.

Numbered Paragraph 23. A method for washing a vehicle using the apparatus of any preceding Numbered Paragraph, the method comprising:
applying water from the first tank onto the vehicle to pre-wash the vehicle; and
applying water from the second tank onto the vehicle to rinse the vehicle.

1-23. (canceled)

24. An apparatus for washing vehicles, the apparatus comprising:
a first tank arranged to receive water from a water supply;
a reverse osmosis system arranged to receive and process water from the water supply;
a demineralisation system, in fluidic communication with the reverse osmosis system, for treating the water treated by the reverse osmosis system; and
a second tank in fluidic communication with the demineralisation system; wherein:
the first tank is arranged to receive untreated water from the water supply, and configured to supply such water for pre-washing the vehicle; and
the second tank is arranged to receive the water treated by the demineralisation system, and configured to supply such water for rinsing the vehicle.

25. The apparatus according to claim 24, wherein the first tank is further configured to receive waste water from the reverse osmosis system.

26. The apparatus according to claim 24, wherein the apparatus further comprises:
a first adjustable pressure pump, in fluidic communication with the first tank, connectable to a first hose, and
a second adjustable pressure pump, in fluidic communication with the second tank, connectable to a second hose.

27. The apparatus according to claim 26, further comprising the first hose and the second hose;
optionally wherein the first hose and the second hose are retractable onto respective reels.

28. The apparatus according to claim 27, wherein the first hose is connectable to a first quick-release pressure vessel, and the second hose is connectable to a second quick-release pressure vessel;
optionally wherein the apparatus further comprises the first quick-release pressure vessel and the second quick-release pressure vessel;
optionally wherein the first quick-release pressure vessel comprises a detergent, and the second quick-release pressure vessel comprises a hydrophobic treatment agent.

29. The apparatus according to claim 24, further comprising a first inlet for receiving water from the water supply, the first inlet being in fluidic communication with the first tank and the reverse osmosis system.

30. The apparatus according to claim 24, wherein the apparatus comprises a meter for measuring the quality of the water received from the water supply, and for measuring the water quality of the treated water.

31. The apparatus according to claim 24, wherein the first pump and the second pump are releasably mounted onto a single plate.

32. The apparatus according to claim 24, wherein the first tank comprises a first float valve operable to shut off a supply inlet of untreated water from the water supply, and the second tank comprises a second float valve operable to shut off a supply inlet of water treated by the demineralisation system.

33. The apparatus according to claim 24, wherein the first and second tanks comprise an overflow outlet.

34. The apparatus according to claim 32, wherein the first and second tanks comprise an overflow outlet, and wherein the first float valve is configured to shut off the supply of untreated water at a lower water level in the first tank than the water level in the second tank at which the second float valve shuts off the supply of water treated by the demineralisation system.

35. The apparatus according to claim 34, wherein the overflow outlet is provided in each of the first tank and second tank at a level below that of the supply inlet of each respective float valve.

36. The apparatus according to claim 24, wherein the apparatus further comprises a one-way valve between the first tank and the first pump, and a one-way valve between the second tank and the second pump.

37. The apparatus according to claim 36, further comprising a first inlet for receiving water from the water supply, the first inlet being in fluidic communication with the first tank and the reverse osmosis system, and further comprising a one-way valve between the water supply and the first inlet.

38. The apparatus according to claim 27, wherein the apparatus is self-contained within a housing.

39. The apparatus according to claim 38, wherein:
the first tank, the second tank, the first pump and the second pump are contained within a central portion of the housing;
the first hose is extendable from a first peripheral portion of the housing; and
the second hose is extendable from a second peripheral portion of the housing.

40. The apparatus according to claim 39, wherein the central portion of the housing comprises:
a first gauge for displaying the volumetric contents of the first tank; and
a second gauge for displaying the volumetric contents of the second tank.

41. The apparatus according to claim 40, wherein the first gauge for displaying the volumetric contents of the first tank comprises a first sight gauge, and wherein the second gauge for displaying the volumetric contents of the second tank comprises a second sight gauge.

42. The apparatus according to claim 38, wherein the central portion of the housing comprises at least one storage portion for storing items.

43. A method for washing a vehicle using the apparatus of claim 24, the method comprising:
applying water from the first tank onto the vehicle to pre-wash the vehicle; and
applying water from the second tank onto the vehicle to rinse the vehicle.
